(19) United States
(12) Patent Application Publication
(10) Pub. No.: US 2011/0161029 A1
(43) Pub. Date: Jun. 30, 2011

(54) SURFACE MOUNT TECHNOLOGY MEASUREMENT SYSTEM AND METHOD

(75) Inventors: CHI-CHIH WANG, Tu-Cheng (TW); RUI-JUN WANG, Shenzhen City (CN); XU-KUN WANG, Shenzhen City (CN); ZHI-LONG LI, Shenzhen City (CN)

(73) Assignees: GDS SOFTWARE (SHENZHEN) CO.,LTD, ShenZhen City (CN); HON HAI PRECISION INDUSTRY CO., LTD., Tu-Cheng (TW)

(21) Appl. No.: 12/824,251

(22) Filed: Jun. 28, 2010

(30) Foreign Application Priority Data
Dec. 30, 2009 (CN) 200910312687.1

(51) Int. Cl. G06F 19/00

(52) U.S. Cl. 702/81

(57) ABSTRACT

In a surface mount technology (SMT) measurement system and method, the number of PCBs input to an SMT production line, the frequency of solder paste printing of the PCBs, the frequency of surface mount component placement of the PCBs, and a yield of the PCBs are calculated. Accordingly, production performance of the SMT production line is determined. The production performance is output to an output device.

### BACKGROUND

1. Technical Field

Embodiments of the present disclosure relate to measurement systems and methods, and particularly to a surface mount technology (SMT) measurement system and method.

2. Description of Related Art

Nowadays, printed circuit boards (PCBs) are increasingly assembled using SMT technology. In SMT production lines, solder paste is printed onto solder pads of PCBs, surface mount components are placed on the solder pads of the PCBs, and the solder paste are heated, bonding component leads of the surface mount components to the solder pads of the PCBs. In order to take actions to improve SMT manufacturing, production performance of the SMT production lines is required to be measured.

### BRIEF DESCRIPTION OF THE DRAWINGS

FIG. 1 is a block diagram of one embodiment of an application environment of a surface mount technology (SMT) measurement system.

FIG. 2 is a detailed block diagram of one embodiment of an SMT production line in FIG. 1.

FIG. 3 is a block diagram of one embodiment of a measurement unit in FIG. 1.

FIG. 4 is a flowchart of one embodiment of an SMT measurement method implement an SMT measurement system, such as that in FIG. 1.

### DETAILED DESCRIPTION

In general, the word “module,” as used herein, refers to logic embodied in hardware or firmware, or to a collection of software instructions, written in a program language. In one embodiment, the program language may be Java or C. One or more software instructions in the modules may be embedded in firmware, such as an EPROM. The modules described herein may be implemented as either software and/or hardware modules and may be stored in any type of computer-readable medium or other storage device.

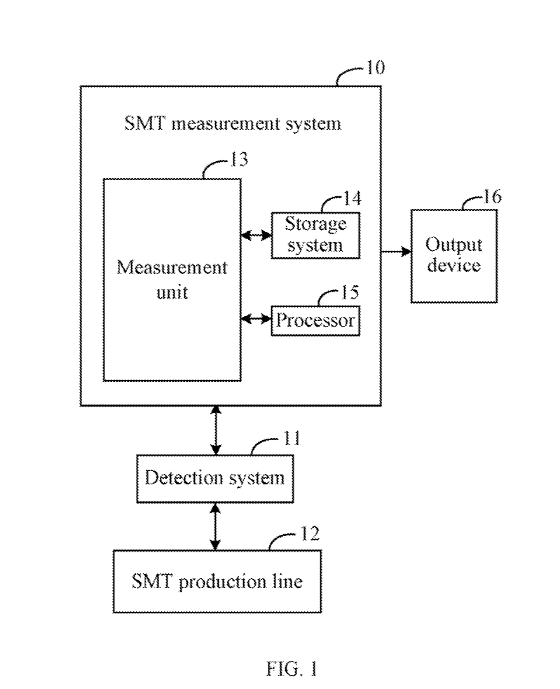

FIG. 1 is a block diagram of one embodiment of an application environment of a surface mount technology (SMT) measurement system 10. In the embodiment, the SMT measurement system 10 may be connected to a detection system 11 that obtains detection data of an SMT production line 12. The SMT measurement system 10 determines production performance of the SMT production line 12 according to the detection data. In one embodiment, the detection system 11 may use sensors (e.g., infrared sensors or microwave sensors) positioned in the SMT production line 12 to obtain the detection data. The SMT measurement system 10 may be further connected to an output device 16 such as a display screen or a printer, which outputs measurement results of the SMT production line 12 to users. The SMT measurement system 10 may be a data processing device or a computerized device such as a personal computer, an application server, or a workstation, for example.

In one embodiment, the SMT measurement system 10 includes a measurement unit 13, a storage system 14, and a processor 15. One or more computerized codes of the measurement unit 13 may be stored in the storage system 14 and executed by the processor 15. The storage system 14 may include a flash memory, a hard disk drive, and a cache.

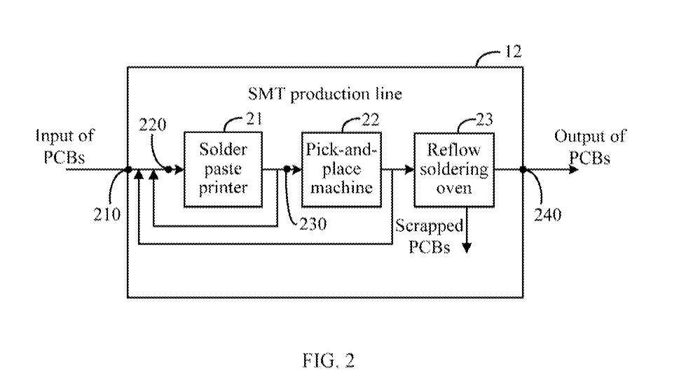

FIG. 2 is a detailed block diagram of one embodiment of the SMT production line 12 in FIG. 1. In the embodiment, the SMT production line 12 may include a solder paste printer 21, a pick-and-place machine 22, and a reflow soldering oven 23. The solder paste printer 21 prints solder paste onto solder pads of printed circuit boards (PCBs). The pick-and-place machine 22 picks surface mount components from containers such as trays, and places the surface mount components on the solder pads of the PCBs. The reflow soldering oven 23 melts solder particles in the solder paste, bonding the component leads of the surface mount components to the solder pads of the PCBs.

In SMT manufacturing, if the solder paste printer 21 fails to print solder paste onto a PCB, the PCB is solder paste reprinted. If the pick-and-place machine 22 fails to place surface mount components on a PCB, the PCB is solder paste reprinted and surface mount components replaced. If the reflow soldering oven 23 fails to reflow solder on a PCB, the PCB is fixed. A PCB may become defective and un-repairable during the reflow soldering process. In this case, the PCB is scrapped. In one embodiment, the detection system 11 arranges sensors 210-240 positioned in the SMT production line 12 as shown in FIG. 2, to obtain the detection data of the SMT production line 12. Further details will be described below.

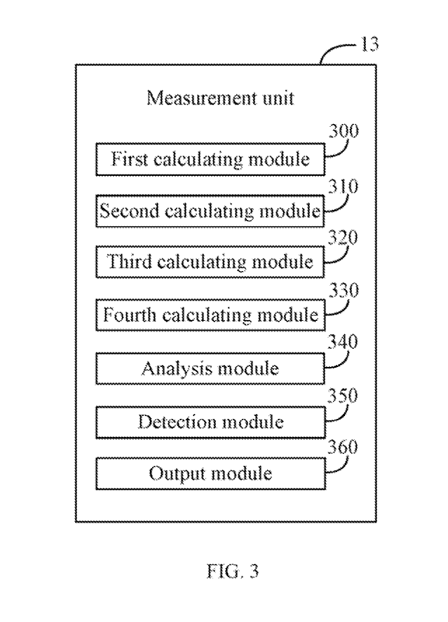

FIG. 3 is a block diagram of one embodiment of the measurement unit 13 in FIG. 1. In one embodiment, the measurement unit 13 may include a first calculation module 300, a second calculation module 310, a third calculation module 320, a fourth calculation module 330, an analysis module 340, a detection module 350, and an output module 360.

The first calculation module 300 calculates the number of PCBs input to the SMT production line 12. In one embodiment with respect to FIG. 2, the first calculation module 300 uses the sensor 210 positioned at the entrance of the SMT production line 12 to detect PCBs entering the SMT production line 12. Accordingly, the first calculation module 300 calculates the number of the PCBs. In one example, the number of the PCBs is 10.

The second calculation module 310 calculates the frequency of solder paste printing of the PCBs. In one embodiment with respect to FIG. 2, the second calculation module 310 may use the sensor 220 positioned before the solder paste printer 21 to detect PCBs going into solder paste printing process. Accordingly, the second calculation module 310 calculates the frequency of solder paste printing of the PCBs. In one example, the frequency of solder paste printing of the PCBs is 15.

The third calculation module 320 calculates the frequency of surface mount component placement of the PCBs. In one embodiment with respect to FIG. 2, the third calculation module 320 may use the sensor 230 positioned before the pick-and-place machine 22 to detect a PCB going into surface mount component placement process. Accordingly, the third calculation module 320 calculates the frequency of surface mount component placement of the PCBs. In one example, the frequency of solder paste printing of the PCBs is 15.

The fourth calculation module 330 calculates a yield of the PCBs in the SMT production line 12. In one embodiment with respect to FIG. 2, the fourth calculation module 330 uses the sensor 240 positioned after the reflow solder oven 23 to detect PCBs output from the SMT production line 12. Accordingly, the fourth calculation module 330 calculates the yield of the PCBs. It may be understood that PCBs output from the SMT production line 12 are quality products. In one example, the yield of the PCBs is 9.

The analysis module 340 analyzes production performance of the SMT production line 12 according to the number of the PCBs, the frequency of solder paste printing of the PCBs, the frequency of surface mount component placement of the PCBs, and the yield of the PCBs. In one embodiment, the analysis module 340 may calculate a first time yield rate of solder paste printing, a first time yield rate of surface component placement, and a total yield rate of SMT manufacturing 12 to determine the production performance of the SMT production line 12. Further details will be described below.

The detection module 350 detects whether there are sufficient surface mount components in the SMT production line 12. In one embodiment, the detection module 350 may detect whether there are sufficient surface mount components in the SMT production line 12 by weighing the surface mount components provided in the SMT production line 12.

The output module 360 outputs the production performance of the SMT production line 12 to the output device 16. In one embodiment, the output module 360 outputs the first time yield rate of solder paste printing, the first time yield rate of surface component placement, and the total yield rate of SMT manufacturing 12 to the output device 16.

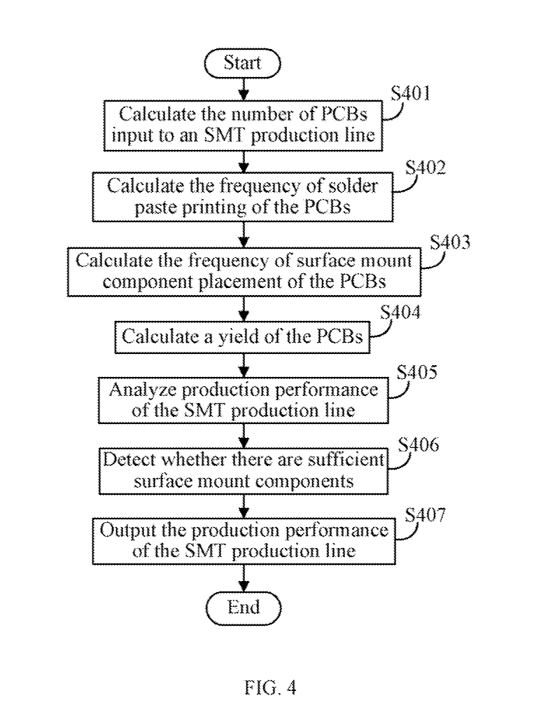

FIG. 4 is a flowchart of one embodiment of an SMT measurement method implementing an SMT measurement system, such as that in FIG. 1. The method may be used to analyze production performance of the SMT production line 12. Depending on the embodiments, additional blocks may be added, others removed, and the ordering of the blocks may be changed.

In block S401, the first calculation module 300 calculates the number of PCBs input to the SMT production line 12. In one embodiment with respect to FIG. 2, the sensor 210 may be positioned at the entrance of the SMT production line 12. The sensor 210 may signal the first calculation module 300 when detecting a PCB entering the SMT production line 12. The first calculation module 300 may increase the number of PCBs by one when signaled by the sensor 210. In one example, the number of the PCBs is 10.

In block S402, the second calculation module 310 calculates the frequency of solder paste printing of the PCBs. As mentioned above, a PCB may be solder paste reprinted if the solder paste printer 21 fails to print solder paste onto the PCB, or if the pick-and-place machine 22 fails to place surface mount components on the PCB. Therefore, the frequency of solder paste printing of the PCBs may be larger than the number of the PCBs due to the rework. In one example, the number of PCBs is 10, and the frequency of solder paste printing of the PCBs is 15. In one embodiment with respect to FIG. 2, the detection system 11 may position the sensor 220 before the solder paste printer 21. The sensor 220 may signal the second calculation module 310 when detecting a PCB going into the solder paste printing process. The second calculation module 310 may increase the frequency of solder paste printing of PCBs by one when signaled by the sensor 220.

In block S403, the third calculation module 320 calculates the frequency of surface mount component placement of the PCBs. As mentioned above, PCB surface mount components may be replaced if the pick-and-place machine 22 fails to place surface mount components on the PCB. Therefore, the frequency of solder paste printing may be larger than the number of the PCBs due to rework. In one example, the number of PCBs is 10, and the frequency of solder paste printing of the PCBs is 15. In one embodiment with respect to FIG. 2, the detection system 11 may position the sensor 230 before the pick-and-place machine 22. The sensor 230 may signal the third calculation module 320 when detecting a PCB entering the surface mount component placement process. The third calculation module 320 may increase the frequency of surface mount component placement of the PCB by one when signaled by the sensor 230.

In block S404, the fourth calculation module 330 calculates a yield of the PCBs in the SMT production line 12. As mentioned above, a PCB may be scrapped if the PCB becomes defective and un-repairable during reflow soldering process. Therefore, the yield of the PCBs may be less than the number of the PCBs due to scrap. In one example, the number of the PCBs is 10, and the yield of the PCBs is 9. In one embodiment, the detection system may position the sensor 240 after the reflow solder oven 23. The sensor 240 may signal the fourth calculation module 330 if detecting a PCB output from the SMT production line 12. The fourth calculation module 330 may increase the yield of the PCBs by one when signaled by the sensor 240.

In block S405, the analysis module 340 analyzes production performance of the SMT production line 12 according to the number of the PCBs, the frequency of solder paste printing of the PCBs, the frequency of surface mount component placement of the PCBs, and the yield of the PCBs. In one embodiment, the analysis module 340 calculates a first time yield rate of solder paste printing, a first time yield rate of surface component placement, and a total yield rate of SMT manufacturing 12 to determine the production performance of the SMT production line 12.

In one example, the number of the PCBs is denoted as N1, the frequency of solder paste printing of the PCBs is denoted as N2, the frequency of surface mount component placement of the PCBs is denoted as N3, and the total yield of the SMT production line 12 is denoted as N4. The first time yield rate of solder paste printing may be calculated as [N1−(N2−N3)]/N1. The first time yield rate of surface component placement may be calculated as [N1−(N3−N1)]/N1. The total yield rate of SMT manufacturing 12 may be calculated as N4/N1. In one example, the number of the PCBs is 10, the frequency of solder paste printing of the PCBs is 15, the frequency of surface mount component placement of the PCBs is 12, and the yield of the PCBs is 9. Therefore, the first time yield rate of solder paste printing is 70%. The first time yield rate of surface component placement is 80%. The total yield rate of SMT manufacturing 12 is 90%.

In block S406, the detection module 350 detects whether there are sufficient surface mount components in the SMT production line 12. In one embodiment, the detection module 350 may detect whether there are sufficient surface mount components in the SMT production line 12 by weighing the surface mount components provided in the SMT production line 12. In one example, the surface mount components are placed on trays. The detection module 350 weighs the surface mount components on the trays to determine if there are sufficient surface mount components in the SMT production line 12.

In block S407, the output module 360 outputs the production performance of the SMT production line 12 to the output device 16. In one embodiment, the output module 360 outputs the first time yield rate of solder paste printing, the first time yield rate of surface component placement, and the total yield rate of SMT manufacturing 12 to the output device 16. The output module 360 may further signal an alarm message to the output device if a shortage of surface mount components is detected.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A surface mount technology (SMT) measurement system, the measurement system comprising:
a storage system;
at least one processor;
a measurement unit being stored in the storage system and executable by the at least one processor, the measurement unit comprising:
a first calculation module operable to calculate the number of PCBs input to an SMT production line;
a second calculation module operable to calculate the frequency of solder paste printing of the PCBs in the SMT production line;
a third calculation module to operable to calculate the frequency of surface mount component placement of the PCBs in the SMT production line;
a fourth calculation module operable to calculate a yield of the PCBs in the SMT production line;
an analysis module operable to analyze production performance of the SMT production line according to the number of the PCBs, the frequency of solder paste printing of the PCBs, the number of times of surface component placement of the PCBs, and the yield of the PCBs; and
an output module operable to output the production performance of the SMT production line to an output device.

2. The measurement system of claim 1, wherein the measurement unit further comprises a detection module operable to detect if there are sufficient surface mount components in the SMT production line.

3. The measurement system of claim 2, wherein the output module further outputs an alarm message to the output device upon the condition that there are not sufficient surface mount components in the SMT production line.

4. The measurement system of claim 1, wherein the analysis module calculates a first time yield rate of solder paste printing, a first time yield rate of surface component placement, and a total yield rate of SMT manufacturing to determine the production performance of the SMT production line.

5. The measurement system of claim 1, wherein the output device is a display screen or a printer.

6. A surface mount technology (SMT) measurement method, comprising:
calculating the number of PCBs input to an SMT production line;
calculating the frequency of solder paste printing of the PCBs in the SMT production line;
calculating the frequency of surface mount component placement of the PCBs in the SMT production line;
calculating a yield of the PCBs in the SMT production line;
analyzing production performance of the SMT production line according to the number of the PCBs, the frequency of solder paste printing of the PCBs, the frequency of surface component placement of the PCBs, and the yield of the PCBs; and
outputting the production performance of the SMT production line to an output device.

7. The method of claim 6, further comprising:
detecting if there are sufficient surface mount components in the SMT production line.

8. The method of claim 7, further comprising:
outputting an alarm message to the output device upon the condition that there are not sufficient surface mount components in the SMT production line.

9. The method of claim 6, wherein the production performance of the SMT production line is determined by a first time yield rate of solder paste printing, a first time yield rate of surface component placement, and a total yield rate of SMT manufacturing.

10. The method of claim 6, wherein the output device is a display screen or a printer.

11. A computer-readable medium having stored thereon instructions that, when executed by at least one processor of a computerized device, causes the computerized device to execute a surface mount technology (SMT) measurement method, the method comprising:
calculating the number of PCBs input to an SMT production line;
calculating the frequency of solder paste printing of the PCBs in the SMT production line;
calculating the frequency of surface mount component placement of the PCBs in the SMT production line;
calculating a yield of the PCBs in the SMT production line;
analyzing production performance of the SMT production line according to the number of the PCBs, the frequency of solder paste printing of the PCBs, the frequency of surface component placement of the PCBs, and the yield of the PCBs; and
outputting the production performance of the SMT production line to an output device.

12. The computer-readable medium of claim 11, wherein the method further comprises:
detecting if there are sufficient surface mount components in the SMT production line.

13. The computer-readable medium of claim 11, wherein the method further comprises:
outputting an alarm message to the output device upon the condition that there are not sufficient surface mount components in the SMT production line.

14. The computer-readable medium of claim 11, wherein the production performance of the SMT production line is determined by a first time yield rate of solder paste printing, a first time yield rate of surface component placement, and a total yield rate of SMT manufacturing.

15. The computer-readable medium of claim 11, wherein the output device is a display screen or a printer.
